(19) United States
(12) Patent Application Publication
(10) Pub. No.: US 2021/0304315 A1
(43) Pub. Date: Sep. 30, 2021

(54) Flight characteristics analysis system, device, and method

(71) Applicants: Braeden G. Whitecotton, Vero Beach, FL (US); Carlos Lagomarsino, Vero Beach, FL (US)

(72) Inventors: Braeden G. Whitecotton, Vero Beach, FL (US); Carlos Lagomarsino, Vero Beach, FL (US)

(21) Appl. No.: 16/858,602

(22) Filed: Apr. 25, 2020

Related U.S. Application Data
(60) Provisional application No. 63/002,557, filed on Mar. 31, 2020.

(51) Int. Cl. G06Q 40/08; B64F 5/60

(52) U.S. Cl. CPC G06Q 40/08; B64F 5/60

(57) ABSTRACT

A flight characteristics analysis system for determining a safe flight score includes a flight characteristics analysis server, including a safe flight model; a flight safety monitoring server; an insurance calculation server, including a premium calculator; and a flight recorder device, including a flight data recorder, a flight data log, and flight data sensors; such that the flight recorder device collects flight data measurements from an aircraft; such that the flight characteristics analysis server compares flight data measurements with the safe flight model for the aircraft, in order to extract a list of safe flight deviations, such that the list of safe flight deviations is used to calculate a safe flight score; such that the flight safety monitoring server stores a plurality of safe flight scores for a plurality of aircraft; and such that insurance calculation server calculates an insurance premium based on the safe flight score.

### CROSS-REFERENCE TO RELATED APPLICATIONS

This application claims the benefit of U.S. Provisional Application No. 63/002,557, filed Mar. 31, 2020; which is hereby incorporated herein by reference in its entirety.

### FIELD OF THE INVENTION

The present invention relates generally to the field of vehicle sensor collecting systems, and more particularly to methods and systems for collecting flight sensor data, in order to determine a safe flight score, which can be used by aviation authorities to assess safe flying behavior, by aircraft manufacturers to monitor aircraft usage, by aircraft owners to log their flights, and by insurance companies to calculate an insurance premium.

### BACKGROUND OF THE INVENTION

Systems for collecting sensor data to determine driver behavior in order to calculate insurance premiums are well-known, but there are no systems which are specifically designed for the unique environment of aviation, and consequently there are no available flight data collectors suitable for such applications in aviation.

Conventional devices used to log aircraft data are generally too expensive for the market, are not universally applicable, and are not able to be installed without a supplemental type certificate or associated paperwork, and may fail to log the data required by the end user. Traditional telemetry recorders are built for specific devices or instruments to be recorded, but are not universally compatible with any airframe, and generally do not integrate with other aviation applications, systems, or devices.

As such, considering the foregoing, it may be appreciated that there continues to be a need for novel and improved devices and methods for methods and systems for collecting flight sensor data, in order to calculate an insurance premium.

### SUMMARY OF THE INVENTION

The foregoing needs are met, to a great extent, by the present invention, wherein in aspects of this invention, enhancements are provided to the existing model of Systems for collecting sensor data in order to determine insurance premiums.

In an aspect, a flight characteristics analysis system for determining a safe flight score for monitoring of flight safety and for calculation of insurance premiums can include:
a) A flight characteristics analysis server, which can include:
   a safe flight model, which includes aircraft safety models for a plurality of aircraft types, including a corresponding aircraft model for an aircraft;
b) A flight safety monitoring server;
c) An insurance calculation server; and
d) A flight recorder device, which is mounted in the aircraft;
wherein the flight recorder device collects flight data measurements from the aircraft, such that the flight data measurements can be stored in a flight data log;
wherein the flight characteristics analysis server compares the flight data measurements with a safe flight model for the aircraft, in order to extract a list of safe flight deviations, such that the list of safe flight deviations can be used to calculate a safe flight score;
wherein the flight safety monitoring server stores a plurality of safe flight scores for a plurality of aircraft, including the safe flight score for the aircraft, such that an aviation authority user can perform regional and aircraft type specific analysis of general flight safety, and such that the aviation authority can investigate owners and pilots of the aircraft for specific and/or general
flight safety violations;

wherein the insurance calculation server can calculate an adjusted insurance premium based on the safe flight score.

In another aspect, a flight characteristics analysis system for determining a safe flight score for calculation of insurance premiums can include:
a) An insurance calculation server; and
b) A flight recorder device, which is mounted in an aircraft;
wherein the flight recorder device collects flight data measurements from the aircraft, such that the flight data measurements are stored in a flight data log;
wherein the insurance server compares the flight data measurements with a safe flight model for the aircraft, in order to extract a list of safe flight deviations, such that the list of safe flight deviations is used to calculate a safe flight score;
wherein the insurance calculation server calculates an insurance premium based on the safe flight score.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a schematic diagram illustrating a system for flight characteristics analysis, according to an embodiment of the invention.

FIG. 1B is a schematic diagram illustrating a system for flight characteristics analysis, according to an embodiment of the invention.

FIG. 2A is a schematic diagram illustrating a flight characteristics analysis server, according to an embodiment of the invention.

FIG. 2B is a schematic diagram illustrating an insurance calculation server, according to an embodiment of the invention.

FIG. 2C is a schematic diagram illustrating an insurance calculation server, according to an embodiment of the invention.

FIG. 3 is a schematic diagram illustrating a flight recorder device, according to an embodiment of the invention.

FIG. 4 is a flowchart illustrating steps that may be followed, in accordance with one embodiment of a method or process of flight characteristics analysis.

FIG. 5 is a schematic diagram illustrating a flight data log including a plurality of flight data measurements, according to an embodiment of the invention.

FIG. 6 is a schematic diagram illustrating a safe flight model, according to an embodiment of the invention.

FIG. 7 is a schematic diagram illustrating a data flow for the system for flight characteristics analysis, according to an embodiment of the invention.

FIG. 8 is a front view of a mobile device of the system for flight characteristics analysis, according to an embodiment of the invention.

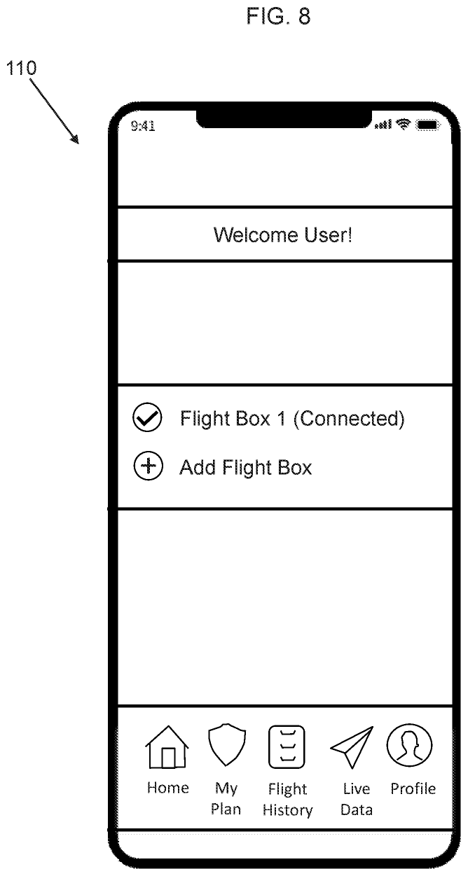

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

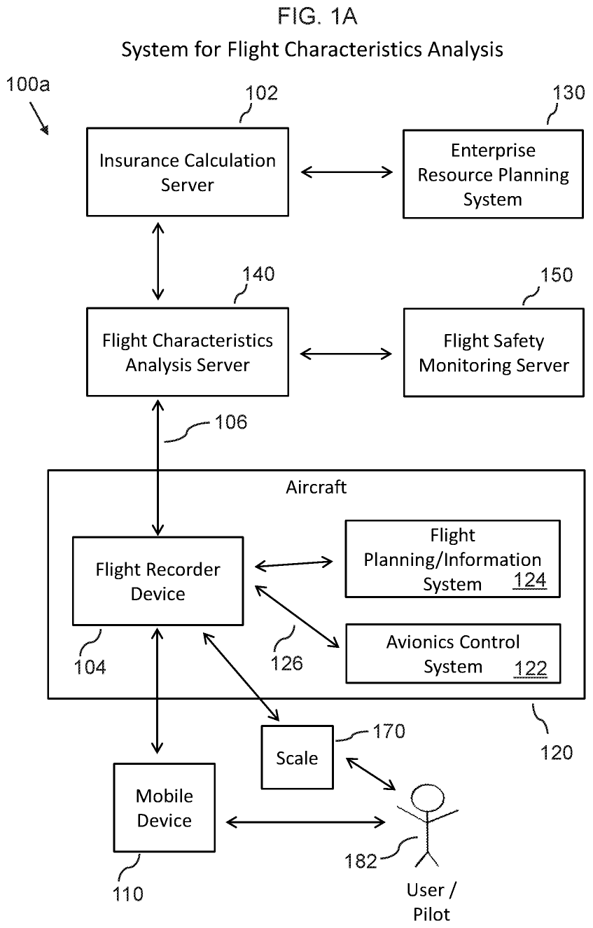

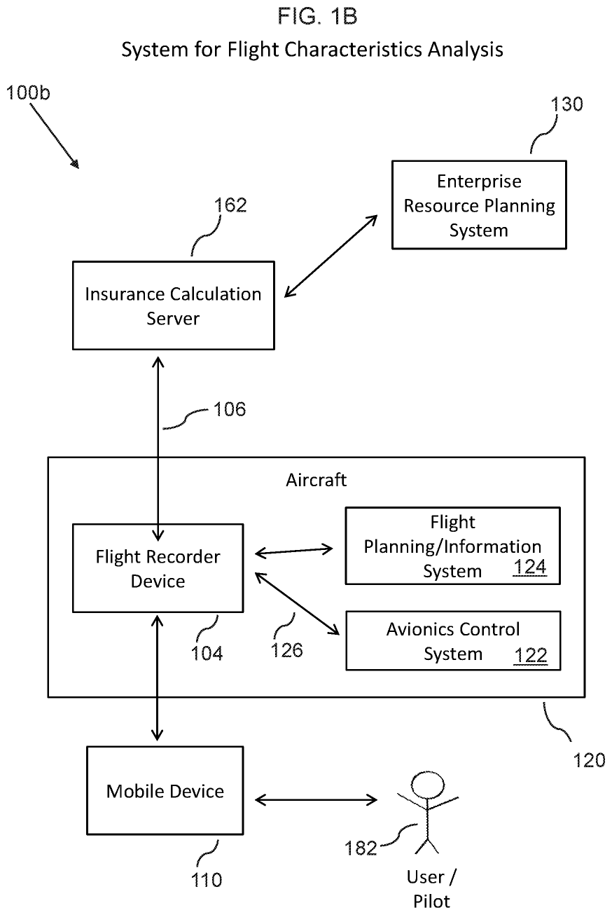

In the following, we describe the structure of an embodiment of a system for flight characteristics analysis system 100a, 100b with reference to FIGS. 1A and 1B, in such manner that like reference numerals refer to like components throughout; a convention that we shall employ for the remainder of this specification.

In various related embodiments, the flight characteristics analysis system 100 provides a system to help establish safe flying characteristics with the intention of improving flight safety and reducing insurance premiums.

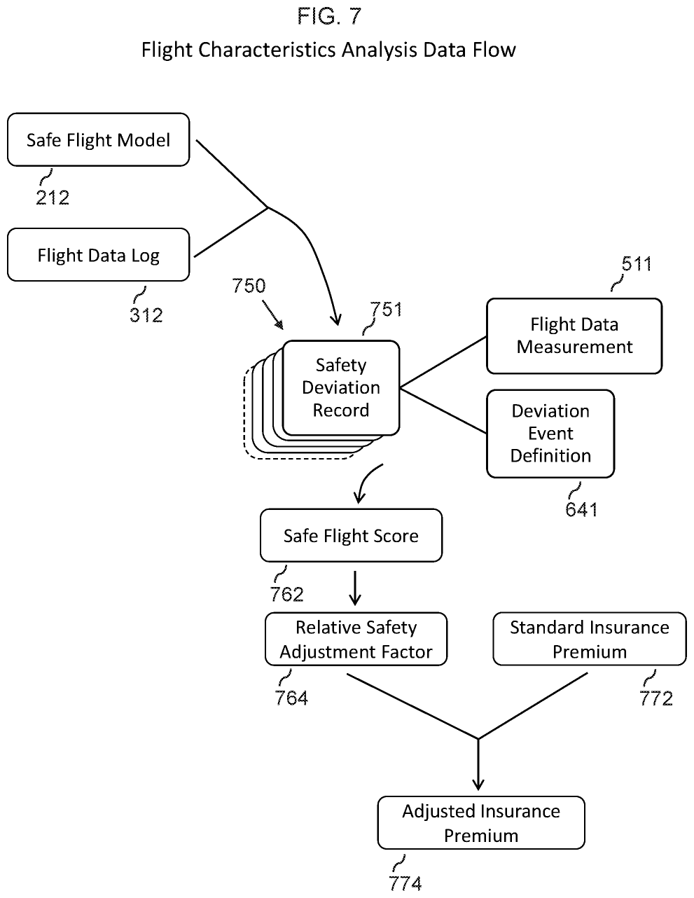

In an embodiment, as shown in FIGS. 1A, 2, 3, 6 and 7, a flight characteristics analysis system 100a for determining a safe flight score for monitoring of flight safety and for calculation of insurance premiums can include:
a) A flight characteristics analysis server 140, which can include:
   i. a safe flight model 212, which includes aircraft safety models 610 for a plurality of aircraft types, including a corresponding aircraft safety model 610 for an aircraft 120, wherein an aircraft type is an aircraft make/model, such as for example a Beechcraft King Air 350i;
b) A flight safety monitoring server 150, which for example can be operated by:
   i. An aviation authority, such as the United States Federal Aviation Authority, to assess safe flying behavior;
   ii. An aircraft manufacturer, to monitor aircraft usage;
   iii. A company to monitor its fleet of aircraft; and/or
   iv. An individual owner to store records about previous flights;
c) An insurance calculation server 102, which for example can be operated by an insurance company; and
d) A flight recorder device 104, which is mounted in an aircraft 120;
wherein the flight recorder device 104 collects flight data measurements 510 from the aircraft 120, such that the flight data measurements 510 can be stored in a flight data log 312;
wherein the flight characteristics analysis server 140 can be configured to compare the flight data measurements 510 with a safe flight model 212 for the aircraft 120, in order to extract a list of safe flight deviations 252, such that the list of safe flight deviations 252 is used to calculate a safe flight score 762;
wherein the flight safety monitoring server 150 stores a plurality of safe flight scores for a plurality of aircraft, including the safe flight score 762 for the aircraft, such that an aviation authority user can perform regional and aircraft type specific analysis of general flight safety, and such that the aviation authority can investigate owners and pilots of the aircraft 120 for specific and/or general flight safety violations;
wherein the insurance calculation server 102 can calculate an adjusted insurance premium (for the aircraft 120) based on the safe flight score 762.

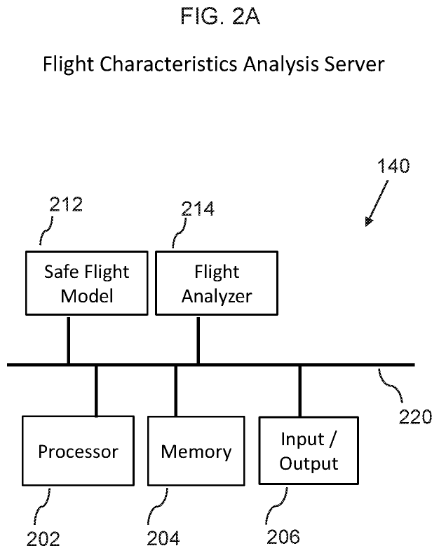

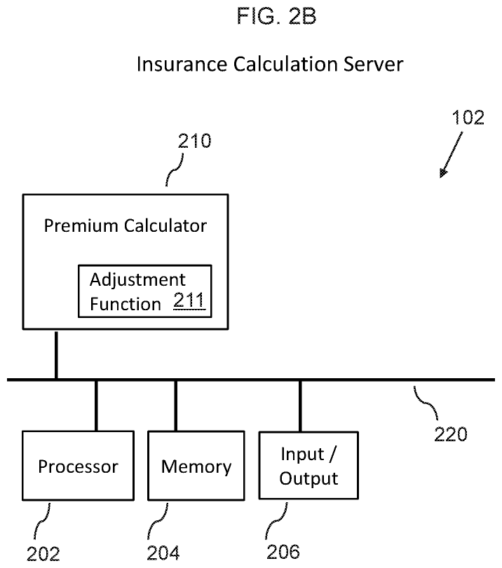

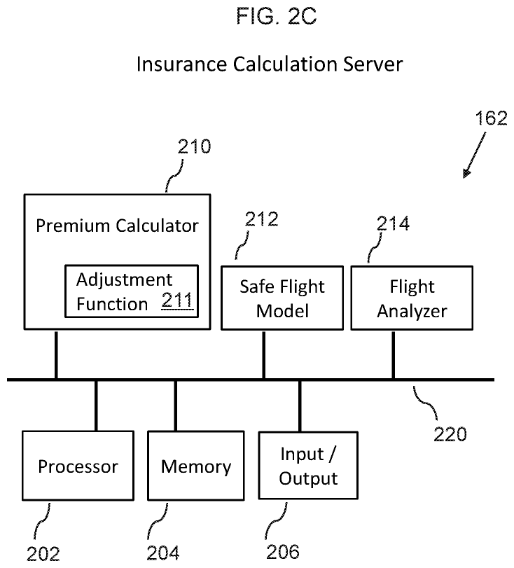

In a related embodiment, as shown in FIG. 2A, a flight characteristics analysis server 140 can include:
a) A first processor 202;
b) A first non-transitory memory 204;
c) A first input/output component 206;
d) A safe flight model 212, which stores parameters that indicate flight within a normal/nominal flight envelope per aircraft type; and
e) A flight analyzer 214, which is configured to compare the flight data measurements with a safe flight model 212 for the aircraft, in order to extract a list of safe flight deviations, such that the flight analyzer 214 calculates a safe flight score from the list of safe flight deviations 510. Flight data measurements 510 can be analyzed on a periodic basis, such as per 1, 5, 10, 40, 160, 200, 500, 1000 flight hours; all connected via
f) A data bus 220.

In another related embodiment, as shown in FIG. 2B, an insurance calculation server 102 can include:
a) A second processor 202;
b) A second non-transitory memory 204;
c) A second input/output component 206;
d) A premium calculator 210, which can be configured to calculate an insurance premium based on the safe flight score; all connected via
e) A data bus 220.

In an alternative embodiment, as shown in FIGS. 1B, 2, 3 and 7, a flight characteristics analysis system 100b for determining a safe flight score for calculation of insurance premiums can include:
a) An insurance calculation server 102; and
b) A flight recorder device 104, which is mounted in an aircraft 120;
wherein the flight recorder device 104 collects flight data measurements 510 from the aircraft 120, such that the flight data measurements 510 are stored in a flight data log 312;
wherein the insurance calculation server 102 is configured to compare the flight data measurements 510 with a safe flight model 212 for the aircraft 120, in order to extract a list of safe flight deviations 252, such that the list of safe flight deviations 252 is used to calculate a safe flight score 762;
wherein the insurance calculation server calculates an adjusted insurance premium (for the aircraft 120) based on the safe flight score 762.

In a related embodiment, as shown in FIG. 2C, an insurance calculation server 162 can include:
a) A processor 202;
b) A non-transitory memory 204;
c) An input/output component 206;
d) A premium calculator 210, which can be configured to calculate an insurance premium based on the safe flight score;
e) A safe flight model 212, which stores parameters that indicate flight within a normal/nominal flight envelope per aircraft type; and
f) A flight analyzer 214, which is configured to compare the flight data measurements with a safe flight model 212 for the aircraft, in order to extract a list of safe flight deviations, such that the flight analyzer 214 calculates a safe flight score from the list of safe flight deviations 510. Flight data measurements 510 can be analyzed on a periodic basis, such as per 1, 5, 10, 40, 160, 200, 500, 1000 flight hours; all connected via
g) A data bus 220.

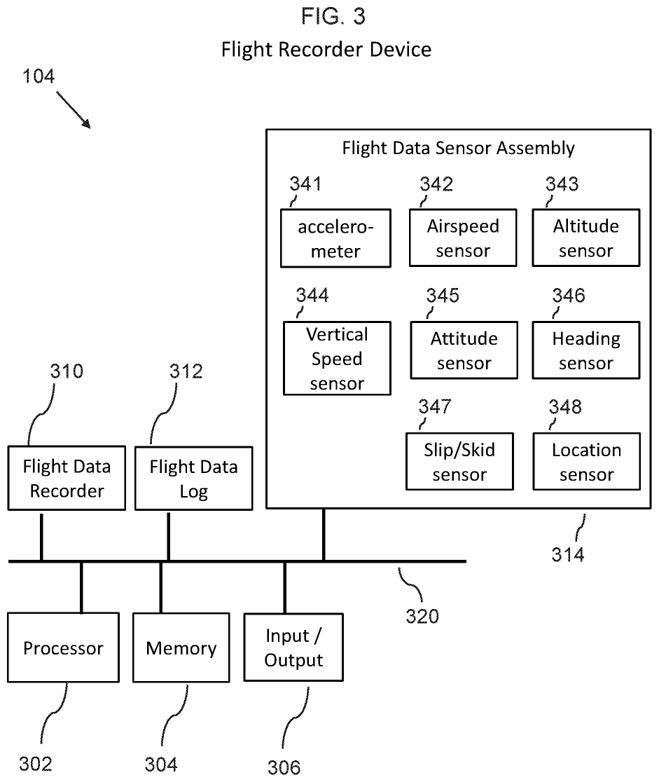

In a related embodiment, as shown in FIG. 3, a flight recorder device 104 can include:
a) A third processor 302;
b) A third non-transitory memory 304;
c) An third input/output component 306;
d) A flight data sensor assembly 314, which can include a plurality of flight sensors, which can include: an accelerometer 341, an airspeed sensor 342, an altitude sensor 343 (measuring height above mean sea level), a vertical speed sensor 344, an attitude sensor 345, a heading sensor 346, a slip and skid sensor 347, a location sensor 348;
e) A flight data recorder 310, which can be configured to collect flight data measurements 510 from the flight data sensor assembly 314, wherein each flight data measurement 511 includes a timestamp 512 and a list of sensor readings from the flight data sensor assembly 314, and optionally (or alternatively) other sensor readings or information values obtained from other connected systems, including from the avionics control system 122 and/or the flight planning/information system 124; wherein the sensor readings can include: an airspeed value 513, an altitude value 514 (measuring height above mean sea level or another height metric), a vertical speed value 515, an attitude value 516, a heading value 517, slip and skid values 518, and a location value 519
f) A flight data log 312, which can store the flight data measurements; and
g) all connected via
h) A data bus 320.

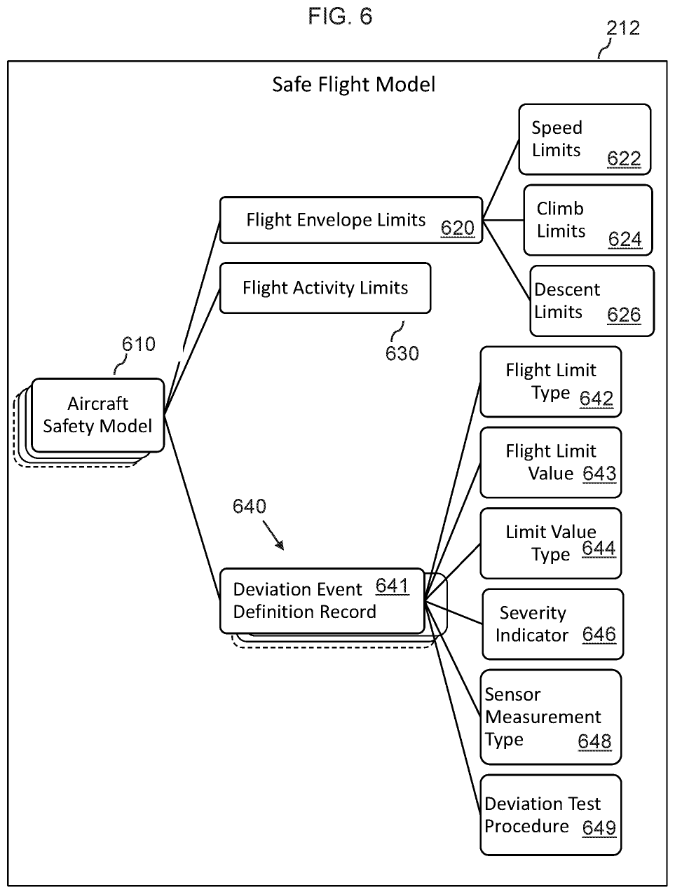

In related embodiment, as shown in FIG. 6, the safe flight model 212 can include flight envelope limits 620, including speed limits 622, which can include some or all of:
a) V₁: The speed beyond which takeoff should no longer be aborted;
b) V₂: Takeoff safety speed. The speed at which the aircraft may safely be climbed with one engine inoperative;
c) V₂ₘᵢₙ: Minimum takeoff safety speed;
d) V₃: Flap retraction speed;
e) V₄: Steady initial climb speed. The all engines operating take-off climb speed used to the point where acceleration to flap retraction speed is initiated;
f) V_{A}: Design maneuvering speed. This is the speed above which it is unwise to make full application of any single flight control (or “pull to the stops”) as it may generate a force greater than the aircraft's structural limitations;
g) Vₐₜ: Indicated airspeed at threshold, which is usually equal to the stall speed VS0 multiplied by 1.3 or stall speed VS1g multiplied by 1.23 in the landing configuration at the maximum certificated landing mass, though some manufacturers apply different criteria. If both VS0 and VS1g are available, the higher resulting Vat shall be applied. Also called “approach speed”;
h) V_{B} Design speed for maximum gust intensity;
i) V_{C} Design cruise speed, used to show compliance with gust intensity loading;
j) V_{cef} Critical engine failure speed, i.e. the speed during takeoff where the same distance would be required to either continue the takeoff or abort to a stop;
k) V_{D}: Design diving speed, the highest speed planned to be achieved in testing;
l) V_{DF}: Demonstrated flight diving speed, the highest actual speed achieved in testing;
m) V_{EF}: The speed at which the critical engine is assumed to fail during takeoff;
n) V_{F}: Designed flap speed.
o) V_{FC}: Maximum speed for stability characteristics.
p) V_{FE}: Maximum flap extended speed.
q) V_{FTO}: Final takeoff speed.
r) V_{H}: Maximum speed in level flight at maximum continuous power.
s) V_{LE}: Maximum landing gear extended speed. This is the maximum speed at which a retractable gear aircraft should be flown with the landing gear extended;
t) V_{LO}: Maximum landing gear operating speed. This is the maximum speed at which the landing gear on a retractable gear aircraft should be extended or retracted;
u) V_{LOF}: Lift-off speed;
v) V_{MC}: Minimum control speed. The minimum speed at which the aircraft is still controllable with the critical engine inoperative;
w) V_{MCA}: Minimum control speed air. The minimum speed that the aircraft is still controllable with the critical engine inoperative while the aircraft is airborne;
x) V_{MCG}: Minimum control speed ground. The minimum speed that the aircraft is still controllable with the critical engine inoperative while the aircraft is on the ground;
y) V_{MCL}: Minimum control speed in the landing configuration with one engine inoperative;
z) V_{MO}: Maximum operating limit speed;
aa) V_{MU}: Minimum unstick speed;
bb) V_{NE}: Never exceed speed;
cc) V_{NO}: Maximum structural cruising speed or maximum speed for normal operations;
dd) V_{O}: Maximum operating maneuvering speed;
ee) V_{R}: Rotation speed. The speed at which the pilot begins to apply control inputs to cause the aircraft nose to pitch up, after which it will leave the ground.[Note 1]
ff) V_{Ref}: Landing reference speed or threshold crossing speed;
gg) V_{S}: Stall speed or minimum steady flight speed for which the aircraft is still controllable;
hh) V_{S0}: Stall speed or minimum flight speed in landing configuration;
ii) V_{S1}: Stall speed or minimum steady flight speed for which the aircraft is still controllable in a specific configuration;
jj) V_{SR}: Reference stall speed;
kk) V_{SR0}: Reference stall speed in landing configuration;
ll) V_{SR1}: Reference stall speed in a specific configuration;
mm) V_{SW}: Speed at which the stall warning will occur; and/or
nn) V_{TOSS}: Category A rotorcraft takeoff safety speed.

In related embodiment, the flight envelope limits 620 can further include climb 624 and descent limits 626, which for example can include some or all of:
a) Maximum descent rate, for example measured in feet per minute;
b) Maximum ascent/climb rate, for example measured in feet per minute;
c) Maximum positive angle of attack; and/or
d) Maximum negative angle of attack.

In related embodiment, the safe flight model 212 can include flight activity limits 630, which for example can include some or all of:
a) Flight into severe weather;
b) Flight close to ground;
c) Flight into instrument meteorological conditions (IMC) without an IFR clearance;
d) Flight into instrument meteorological conditions (IMC) without an instrument rating; and/or
e) Etc.

In a related embodiment, the safe flight model 212 can include a plurality of deviation event definition records 640, wherein each deviation event definition record 641, can include:
a) A flight envelope/activity limit type 642, also called a flight limit type 642, as defined above, such as minimum control speed, maximum descent rate, etc.;
b) A flight envelope limit value 643;
c) A limit value type 644, which for example can be set to either upper nominal value (which can also be called Safe Maximum) or lower nominal value (which can also be called Safe Minimum); or target nominal value (which can also be called Safe Target Value), such that:
   i. For upper nominal value/“Maximum”: an actual sensor reading above the flight envelope limit value indicates a safe flight deviation;
   ii. For lower nominal value/“Minimum”: an actual sensor reading below the flight envelope limit value indicates a safe flight deviation;
   iii. For target nominal value: an actual sensor reading positive/negative difference to the flight envelope limit value indicates a safe flight deviation, which for example can be established within a predetermined tolerance, such as by percentage or absolute value deviation;
d) A severity indicator 646, which can be a numerical value, which indicates a relative deviation severity, which can be used to weight deviations in order to determine an accumulated safe slight score.
e) A sensor measurement type 648, which is correlated with the flight envelope/activity limit type 642, wherein the sensor measurement type 648 corresponds to a sensor available from the flight data sensor assembly 314. A speed limit will for example correlate with an airspeed sensor 342 in the flight data sensor assembly 314;
f) A deviation test procedure 649, which can be a test script or test definition which defines a logical test to determine if a safety deviation has occurred, such that the deviation test procedure processes a flight data measurement in relation to the flight envelope/activity limit type, the flight envelope limit value, limit category, and sensor measurement type, in order to determine a deviation result, which can for example be “false” or “true”; and

In a related embodiment, the premium calculator 210 can include a premium adjustment function 211, which calculates a relative safety adjustment factor 764 (as a factor such as 0.9 or 1.1) from an input of the safe flight score; such that the premium calculator 210 calculates the adjusted insurance premium 774 as a standard insurance premium 772 (for the specific aircraft make/model and geographical region) multiplied by the relative safety adjustment factor 764. The adjustment function 211 can for example be implemented as a table lookup in an adjustment table, with each row including a safe flight score value 762 and a corresponding relative safety adjustment factor 764.

In another related embodiment, the flight analyzer 214 can be configured to determine the list of safe flight deviations 640 by iterating through the flight data measurements 510, and for each flight data measurement 511:
a) Iterate through all sensor readings 513, 514, 515, 516, 517, 518, 519 in the flight data measurement 511, and for each sensor reading 513, 514, 515, 516, 517, 518, 519:
   i. Identify each corresponding deviation event definition record 641, such that a type of the sensor reading matches a corresponding sensor measurement type 648 of the corresponding deviation event definition record 641, and for each corresponding deviation event definition record 641:
      execute the deviation test procedure 649 using as input the flight data measurement 511, to determine if a safety deviation has occurred, and if a safety deviation has occurred:
         add a safety deviation record 751 to the list of safe flight deviations 750, wherein the safety deviation record 751 can include the flight data measurement 511 and the corresponding deviation event definition record 641.

In another related embodiment, the flight analyzer 214 can be configured to calculate the safe flight score 762 by iterating through the list of safe flight deviations 750, aggregating a count of the safe flight deviations 751, wherein each count is weighted by the severity indicator 646. Alternatively, the safe flight score 762 can be calculated as an aggregation of all severity indicators 646 in the list of safe flight deviations 750.

In a related embodiment, as shown in FIGS. 1A and 1B, a mobile device 110, can communicate with the flight recorder device 104, for example via a wireless connection, such as a cellular connection, WIFI™, or BLUETOOTH™, to enable a user 182 to review data on the flight recorder device 104, or to configure the flight recorder device 104.

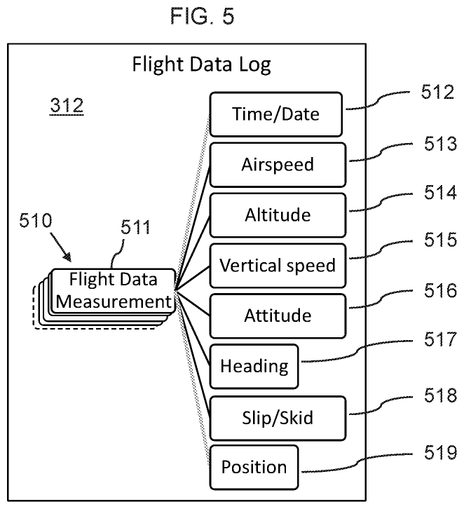

In a further related embodiment, the mobile device 110 can connect to one or more flight recorder devices 104. FIG. 5 shows a flight recorder devices 104, wherein a graphical user interface of the mobile device 110 indicates that the mobile device 110 is connected to a first flight recorder devices 104, and provides an option for connecting additional flight recorder devices 104.

In related embodiments, the flight recorder device 104 can be configured to be universally compatible with any aircraft/airframe, as well as other applications 124 and systems 122. The flight recorder device 104 can be manufactured using inexpensive components, as well as adding connectivity previously not interfaced equipment, in order to enable storage of a more complete flight record. Our system is also self-contained to reduce complexity to the end user as well as creating a device with minimal change to application the system is installed in.

In related embodiment, data can be brought in from the various system receivers or via the mobile device 110, and is processed and recorded onto the devices storage system. Once the device has a stable connection to the off-device storage suite it then offloads the data using SIM card cellular data or a reachable WIFI network.

In a related embodiment, the flight recorder device 104, can be connected with an avionics control system 122 of the aircraft 120, such as for example a GARMIN G1000™ system 122, such that some sensor measurement values can be obtained in communication with the avionics control system 122, or sensor measurement values from the flight data sensor assembly/system 314 of the flight recorder device 104 can be compared with corresponding sensor measurement values from the avionics control system 122 to trigger an inflight deviation alarm, if a difference exceeds a predetermined variation threshold. The flight recorder device 104, can be connected with an avionics control system 122 via an onboard databus 126, such as for example ARINC 429, also called Mark 33 Digital Information Transfer System (DITS), and can use an open or proprietary application programming interface (API).

In another related embodiment, the flight recorder device 104, can be connected with a flight planning/information system 124 of the aircraft 120, such as for example a FOREFLIGHT™ system 124 or an ADS-B system, such that the flight recorder device 104 for example can obtain location information, map information, weather information, etc., from the flight planning/information system 124.

In yet a related embodiment, the flight characteristics analysis system 100a, 100b can further include:
An enterprise resource planning system 130, which can be an insurance management system 130, such that the insurance calculation server is connected with the insurance management system 130, such that the insurance calculation can lookup insurance information and communicate with the enterprise resource planning system 130 in order to create an insurance policy with the calculated insurance premium.

In yet another related embodiment, the flight characteristics analysis system 100a, 100b can further include:
A weighing scale 170, which is connected to the flight recorder device 104, such that the weighing scale 170 can be configured to weigh a pilot user 182, such that a weight of the pilot user 182 can be communicated to the flight recorder device 104, which transmits the weight, in association with the pilot user 182 and a date and time of the weighing, for storage on the flight characteristics analysis server 140.

In a related embodiment, the flight recorder device 104 can include:
a) A cellular wireless transceiver;
b) A SIM card;
c) A WiFi Module;
d) A crash resistant enclosure;
e) Open API for 3rd party integration;
f) Uploads to cloud rescue services, using GPS, Cellular triangulation and last known location;
g) Location ping out to selected users;
h) Multiple voltage power supply, including 5V, 12V, and/or 24V;
i) Bluetooth for smartphone app connection;
j) Battery Backup supply, which for example can support 30 minutes operation at nominal load;
k) Port for external GPS connection;
l) Setup for over the air updates via bluetooth phone link or sim/sd card downloads;
m) A G-Meter;
n) A biometric authenticator, such as a fingerprint reader, facial recognizer, or other biometric function for matching the flight data with a pilot;
o) ADSB in for traffic and weather recording/analysis; and/or
p) Internal or external integration with other flight monitoring or flight safety components or systems 122, 124.

In related embodiments, the mobile device 110 can include configurations as:
a) A web application, executing in a Web browser;
b) A tablet app, executing on a tablet device, such as for example an ANDROID™ or IOS™ tablet device;
c) A mobile app, executing on a mobile device, such as for example an ANDROID™ phone or IPHONE™, or any wearable mobile device;
d) A desktop application, executing on a personal computer, or similar device; or
e) An embedded application, executing on a processing device, such as for example a smart TV, a game console or other system.

It shall be understood that an executing instance of an embodiment of the flight characteristics analysis system 100a, 100b, as shown in FIGS. 1A and 1B, can include a plurality of flight recorder devices 104 (each mounted in a separate aircraft 120), which can each connect to an insurance calculation server 102, 162.

An executing instance of an embodiment of the system for flight characteristics analysis system 100a, 100b, as shown in FIGS. 1A and 1B, can similarly include a plurality of insurance calculation servers 102, 162.

Further, it shall similarly be understood that an executing instance of an embodiment of the flight characteristics analysis system 100a, 100b, as shown in FIGS. 1A and 1B, can include a plurality of mobile devices 110, which are each tied to one or more users 182.

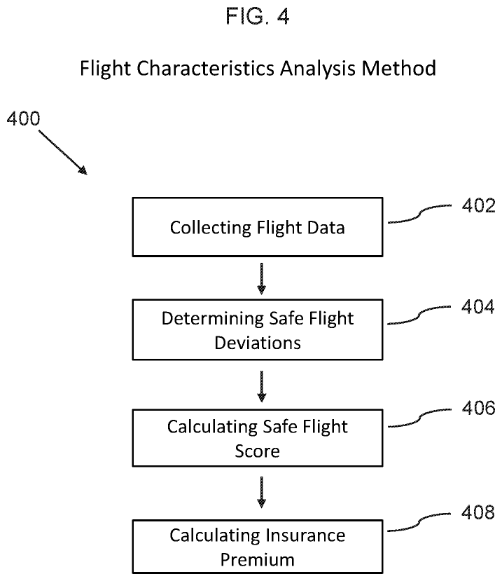

In an embodiment, as illustrated in FIG. 4, a method for flight characteristics analysis 400, can include:
a) Collecting flight data measurements 402 from an aircraft 120, such that the flight data measurements are stored in a flight data log 312;
b) Determining a list of safe flight deviations 404, by comparing the flight data measurements with a safe flight model for the aircraft, in order to extract the list of safe flight deviations;
c) Calculating a safe flight score 406 based on the list of safe flight deviations; and
d) Calculating an insurance premium 408 for the aircraft 120, based on the safe flight score.

FIGS. 1, 2, 3 and 4 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1A, 1B, 2A, 2B, 2C and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIGS. 1A and 1B show a depiction of an embodiment of the flight characteristics analysis system 100a, 100b, including the insurance calculation server 102, 162 and the flight recorder device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as AMAZON EC2™ or MICROSOFT AZURE™.

It shall be understood that the above-mentioned components of the insurance calculation server 102, 162 and the flight recorder device 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the insurance calculation server 102 and the flight recorder device 104 can each respectively include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the flight recorder device 104 communicates with the insurance calculation server 102, 162 over a network 106, which can include the general Internet, a Wide Area Network or a Local Area Network, or another form of communication network, transmitted on wired or wireless connections. Wireless networks can for example include Ethernet, Wi-Fi, BLUETOOTH™, ZIGBEE™, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the . . . device, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the insurance calculation server 102 and the flight recorder device 104. The components of the insurance calculation server 102 can be distributed over a plurality of physical, logical, or virtual servers. Some components of the flight recorder device 104 can be configured to operate in the insurance calculation server 102. Alternatively, parts or all of the components of the insurance calculation server 102 can be configured to operate in the flight recorder device 104.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A flight characteristics analysis system, comprising:
a) a flight characteristics analysis server, which comprises:
a safe flight model, which comprises aircraft safety models for a plurality of aircraft types, including a corresponding aircraft safety model for an aircraft; whereby the safe flight model stores parameters that indicate flight within a nominal flight envelope per aircraft type in the plurality of aircraft types; and
b) a flight recorder device, which is mounted in the aircraft;
wherein the flight recorder device collects flight data measurements from the aircraft;
wherein the flight characteristics analysis server is configured to compare the flight data measurements with the corresponding aircraft safety model for the aircraft, in order to extract a list of safe flight deviations, such that the list of safe flight deviations is used to calculate a safe flight score.

2. The flight characteristics analysis system of claim 1, wherein the flight characteristics analysis server further comprises:
a) a first processor;
b) a first non-transitory memory;
c) a first input/output component; and
d) a flight analyzer, which is configured to compare the flight data measurements with the corresponding aircraft safety model for the aircraft, to extract the list of safe flight deviations, such that the flight analyzer calculates the safe flight score from the list of safe flight deviations.

3. The flight characteristics analysis system of claim 1, further comprising:
a flight safety monitoring server;
wherein the flight safety monitoring server stores a plurality of safe flight scores for a plurality of aircraft, including the safe flight score for the aircraft, such that the flight safety monitoring server is configured to enable an aviation authority user to perform regional and aircraft type specific analysis of general flight safety, and such that the flight safety monitoring server is configured to enable the aviation authority user to investigate owners and pilots of the aircraft for flight safety violations.

4. The flight characteristics analysis system of claim 1, further comprising:
an insurance calculation server;
wherein the insurance calculation server is configured to calculate an adjusted insurance premium based on the safe flight score.

5. The flight characteristics analysis system of claim 4, wherein the insurance calculation server further comprises:
a) a second processor;
b) a second non-transitory memory;
c) a second input/output component; and
d) a premium calculator, which is configured to calculate the adjusted insurance premium based on the safe flight score;
wherein the premium calculator comprises an adjustment function, which calculates a relative safety adjustment factor from an input of the safe flight score; such that the premium calculator calculated the adjusted insurance premium as a standard insurance premium multiplied by the relative safety adjustment factor.

6. The flight characteristics analysis system of claim 2, wherein the flight recorder device further comprises:
a) a third processor;
b) a third non-transitory memory;
c) a third input/output component;
d) a flight data sensor assembly, which comprises a plurality of flight sensors;
e) a flight data recorder, which is configured to collect the flight data measurements from the aircraft, wherein each flight data measurement comprises:
a timestamp; and
a list of sensor readings from the flight data sensor assembly; and
f) a flight data log, which stores the flight data measurements.

7. The flight characteristics analysis system of claim 6, wherein the plurality of flight sensors comprises: an airspeed sensor, an altitude sensor, a vertical speed sensor, an attitude sensor, a heading sensor, a slip and skid sensor, and a location sensor.

8. The flight characteristics analysis system of claim 6, wherein the safe flight model comprises flight envelope limits, comprising speed limits, climb limits, and descent limits.

9. The flight characteristics analysis system of claim 8, wherein the safe flight model further comprises flight activity limits.

10. The flight characteristics analysis system of claim 9, wherein the safe flight model further comprises a plurality of deviation event definition records.

11. The flight characteristics analysis system of claim 10, wherein each deviation event definition record in the plurality of deviation event definition records, comprises:
a) a flight limit type, which is selected from the flight envelope limits and the flight activity limits;
b) a flight envelope limit value;
c) a limit value type, which is selected from an upper nominal value, a lower nominal value, and a target value; and
d) a severity indicator, which indicates a relative deviation severity.

12. The flight characteristics analysis system of claim 11, wherein each deviation event definition record, further comprises:
a) a sensor measurement type, which is correlated with the flight limit type; and
b) a deviation test procedure, which defines a logical test to determine if a safety deviation has occurred, such that the deviation test procedure processes a flight data measurement in relation to the flight limit type, the flight envelope limit value, the limit value type, and the sensor measurement type, to determine a deviation result.

13. The flight characteristics analysis system of claim 12, wherein the flight analyzer can be configured to determine the list of safe flight deviations by iterating through the flight data measurements, and for each flight data measurement:
iterate through all sensor readings in the flight data measurement, and for each sensor reading:
identify each corresponding deviation event definition record, such that a type of the sensor reading matches a corresponding sensor measurement type of the corresponding deviation event definition record, and for each corresponding deviation event definition record:
execute the deviation test procedure using as input the flight data measurement, to determine if the safety deviation has occurred, and if the safety deviation has occurred:
add a safety deviation record to the list of safe flight deviations, wherein the safety deviation record comprises the flight data measurement and the corresponding deviation event definition record.

14. The flight characteristics analysis system of claim 13, wherein the flight analyzer is configured to calculate the safe flight score by iterating through the list of safe flight deviations, aggregating a count of the safe flight deviations, wherein each count is weighted by the severity indicator.

15. The flight characteristics analysis system of claim 1, further comprising:
a weighing scale;
wherein the weighing scale is connected to the flight recorder device, such that the weighing scale is configured to weigh a pilot user, such that a weight of the pilot user is communicated to the flight recorder device, which transmits the weight, in association with the pilot user and a date and time of the weighing, for storage on the flight characteristics analysis server.

16. A flight characteristics analysis method, comprising:
a) collecting a plurality of flight data measurements from an aircraft, such that the flight data measurements are stored in a flight data log;
b) determining a list of safe flight deviations, by comparing the flight data measurements with a safe flight model for the aircraft, in order to extract the list of safe flight deviations;
c) calculating a safe flight score based on the list of safe flight deviations; and
d) calculating an adjusted insurance premium for the aircraft, based on the safe flight score.

17. The flight characteristics analysis method of claim 16, further comprising:
calculating a relative safety adjustment factor by using an adjustment function with an input of the safe flight score, such that the adjusted insurance premium is calculated as a standard insurance premium multiplied by the relative safety adjustment factor.

18. The flight characteristics analysis method of claim 16, wherein each flight data measurement in the plurality of flight data measurements comprises:
a) a timestamp; and
b) a list of sensor readings from the aircraft.

19. The flight characteristics analysis method of claim 18, wherein the safe flight model comprises:
a) flight envelope limits, comprising speed limits, climb limits, and descent limits;
b) flight activity limits; and
c) a plurality of deviation event definition records.

20. The flight characteristics analysis method of claim 19, wherein each deviation event definition record in the plurality of deviation event definition records, comprises:
a) a flight limit type, which is selected from the flight envelope limits and the flight activity limits;
b) a flight envelope limit value;
c) a limit value type, which is selected from an upper nominal value, a lower nominal value, and a target value; and
d) a severity indicator, which indicates a relative deviation severity.

21. The flight characteristics analysis method of claim 20, wherein each deviation event definition record, further comprises:
a) a sensor measurement type, which is correlated with the flight limit type; and
b) a deviation test procedure, which defines a logical test to determine if a safety deviation has occurred, such that the deviation test procedure processes a flight data measurement in relation to the flight limit type, the flight envelope limit value, the limit value type, and the sensor measurement type, to determine a deviation result.

22. The flight characteristics analysis method of claim 21, further comprising: determining the list of safe flight deviations by iterating through the flight data measurements, and for each flight data measurement:
iterating through all sensor readings in the flight data measurement, and for each sensor reading:
identifying each corresponding deviation event definition record, such that a type of the sensor reading matches a corresponding sensor measurement type of the corresponding deviation event definition record, and for each corresponding deviation event definition record:
executing the deviation test procedure using as input the flight data measurement, to determine if the safety deviation has occurred, and if the safety deviation has occurred:
add a safety deviation record to the list of safe flight deviations, wherein the safety deviation record comprises the flight data measurement and the corresponding deviation event definition record.

23. The flight characteristics analysis method of claim 22, further comprising:
calculating the safe flight score by iterating through the list of safe flight deviations, aggregating a count of the safe flight deviations, wherein each count is weighted by the severity indicator.
